(19) United States
(12) Patent Application Publication
(10) Pub. No.: US 2016/0272079 A1
(43) Pub. Date: Sep. 22, 2016

(54) DEVICE AND METHOD FOR RECHARGING ELECTRIC OR HYBRID VEHICLES

(71) Applicant: COMMISSARIAT A L'ENERGIE ATOMIQUE ET AUX ENERGIES ALTERNATIVES, Paris (FR)

(72) Inventors: Tran Quoc-Tuan, Gieres (FR); Van-Linh NGUYEN, Saint Martin D'Heres (FR)

(21) Appl. No.: 15/034,931

(22) PCT Filed: Nov. 4, 2014
(86) PCT No.: PCT/FR2014/052805

§ 371 Date: May 6, 2016

(30) Foreign Application Priority Data
Nov. 19, 2013 (FR) 1361350

(51) Int. Cl. B60L 11/18

(52) U.S. Cl. CPC B60L 11/1844; B60L 11/1861; B60L 11/1848; B60L 2230/22; B60L 2230/24

(57) ABSTRACT

The invention relates to a method for recharging electric or hybrid vehicles (VE₁) by charging stations (B1) connected to an electric power grid (14). The method comprises supplying, for each vehicle to be recharged, a control module (M1) built into said vehicle or to the charging station of said vehicle, with data representing a total electric power required (PS*) for recharging the vehicles, measuring the total electric power (PS) supplied by the electric power grid (14) for recharging the vehicles, and sup- plying data representing the total electric power measured to said control module for each vehicle to be recharged, and determining, by said control module for each vehicle to be recharged, a setting of the electric power for recharging said vehicle according to the difference between the total electric power required and the total electric power measured.

The present patent application claims the priority benefit of French patent application FR13/61350 which is herein incorporated by reference.

### BACKGROUND

The present application relates to a device and to a method for recharging rechargeable electric or hybrid vehicles.

### DISCUSSION OF THE RELATED ART

The number of rechargeable electric vehicles and hybrid vehicles used continuously increases. As an example, the French Electricity Union (UFE: Union Française de l'Electricité) estimates that by 2030, nearly six million rechargeable electric or hybrid vehicles will be in circulation in France.

Such vehicles have batteries which should be regularly recharged by the electric power grid. The recharge of rechargeable electric and hybrid vehicles will have, with no specific measures being taken, a significant impact on the French national power consumption curve. Indeed, one million rechargeable electric or hybrid vehicles in slow simultaneous recharge draw from 3,000 to 6,000 MW.

It is desirable to control the electric power demand for the recharge of rechargeable electric and hybrid vehicles in order to avoid consumption peaks and thus to limit the modifications to be made to the current electric power grid, like the reinforcement of power lines. It is further desirable that the largest possible part of the electric energy used for the recharge of rechargeable electric or hybrid vehicles originates from renewable energy sources, such as photovoltaic power plants, wind power stations, hydraulic power plants, etc.

There exist methods for recharging rechargeable electric or hybrid vehicles which enable to control the electric power supplied to the vehicles. However, such methods generally require communicating, to a management module, a number of parameters relative to the electric or hybrid vehicles to be recharged, for example, the vehicle type, the capacity of the battery of each vehicle, the recharge profile of the battery of each vehicle, etc. It may be difficult to collect a large number of data to transmit them to the management module. Further, such methods may require controlling the number of vehicles to be recharged while this number is in practice variable and/or controlling the times of beginning or of end of recharge while these times can in practice not be controlled. Further, when the recharge is performed from the electric energy provided by a renewable energy electric power plant, recharge methods may require knowing an estimate of the energy which will be supplied by this power plant. However, such an estimate may be unavailable or be different from the real production of electric energy by the electric power plant.

### SUMMARY

An object of an embodiment is to overcome all or part of the disadvantages of previously-described methods and devices for recharging rechargeable electric and hybrid vehicles.

Another object of an embodiment is to limit the number of data relative to the vehicles to be recharged necessary for the implementation of the recharge method.

Another object of an embodiment is that the recharge method can be implemented in real time.

Another object of an embodiment is that it enables to favor the use of renewable energies for the recharge of vehicles.

Thus, an embodiment provides a method of recharging electric or hybrid vehicles by means of charging stations connected to an electric power grid, the method comprising the steps of:

supplying, for each vehicle to be recharged, a control module built into said vehicle or into the charging station of said vehicle with data representative of a total electric power required for recharging the vehicles;

measuring the total electric power supplied by the electric power grid for recharging the vehicles and supplying data representative of the measured total electric power to said control module for each vehicle to be recharged; and

determining, by means of said control module for each vehicle to be recharged, a setting of the electric charge power of said vehicle based on the difference between the required total electric power and the measured total electric power.

According to an embodiment, the setting for the electric charge power of said vehicle is further determined based on the state of charge of the vehicle, on the recharge time of the vehicle.

According to an embodiment, the data representative of the required total electric power are supplied by the power grid manager and/or by at least one electric power plant selected from the group comprising a photovoltaic power plant, a wind power station, a hydraulic power plant, or a tidal power station.

According to an embodiment, the method comprises determining, by means of said control module for each vehicle to be recharged, a first coefficient by fuzzy logic based on the state of charge of the vehicle and the recharge time of the vehicle and determining the setting for the electric charge power of said vehicle based on the first coefficient.

According to an embodiment, the method further comprises the step of multiplying the maximum electric charge power of said vehicle by a second coefficient obtained from the first coefficient and from the measured total electric power.

According to an embodiment, the method comprises the steps of:
determining the difference between the required total electric power and the measured total electric power; and
determining the second coefficient based on the product between the first coefficient and said difference.

According to an embodiment, the second coefficient is equal to the integral of the product between the first coefficient and said difference.

According to an embodiment, the determination of the first coefficient by fuzzy logic comprises determining first values of first membership functions of first fuzzy sets associated with the state of charge of the vehicle and of second values of second membership functions of second fuzzy sets associated with the vehicle recharge time.

According to an embodiment, the determination of the first coefficient by fuzzy logic comprises using a first inference table and a third membership function for the first coefficient on decrease of the required total electric power, and a second inference table, different from the first inference table, and a fourth membership function for the first coefficient different from the third membership function, on increase of the required total electric power.

An embodiment also provides a device for recharging electric and hybrid vehicles, comprising charging stations connected to an electric power grid, each charging station being connected to one of the vehicles to be recharged, the device further comprising, for each vehicle to be recharged, a control module built into said vehicle or into the charging station of said vehicle, the device comprising means for transmitting, to the control module for each vehicle to be recharged, data representative of a total electric power required for recharging the vehicles, the device further comprising a sensor capable of measuring the total electric power supplied by the electric power grid for recharging said vehicles and means for transmitting data representative of the measured total electric power to said control module for each vehicle to be recharged, said control module for each vehicle to be recharged being capable of determining a setting for the electric power for recharging said vehicle based on the state of charge of the vehicle, on the recharge time of the vehicle, and on the difference between the required total electric power and the measured total electric power.

### BRIEF DESCRIPTION OF THE DRAWINGS

The foregoing and other features and advantages will be discussed in detail in the following non-limiting description of specific embodiments in connection with the accompanying drawings, among which:

FIG. 1 partially and schematically shows an embodiment of a device for recharging rechargeable electric or hybrid vehicles;

FIG. 2 shows in more detailed fashion a portion of FIG. 1;

FIG. 3 shows in the form of a block diagram an embodiment of a method of recharging a rechargeable electric or hybrid vehicle;

FIGS. 4, 5, 6A, and 6B show curves of the variation of membership functions of fuzzy sets, respectively of the variables of state of charge, recharge time, and variation coefficient k of the electric charge power for two operating modes, implemented by an embodiment of a method of recharging rechargeable electric or hybrid vehicles;

FIGS. 7 and 8 show examples of three-dimensional surfaces of variation of coefficient k according to the state of charge and to the recharge time for two variation configurations of the available total electric power;

FIGS. 9 and 10 illustrate the principle of determination of coefficient k for two examples of variation of the available electric power;

FIGS. 11A, 11B, and 11C show curves of the variation, respectively, of the states of charge of vehicles to be recharged, of the electric power supplied to each vehicle, and of the total electric power supplied to the vehicles in the absence of a control of the electric power supplied to each vehicle; and

FIGS. 12A, 12B, and 12C, 13A, 13B, and 13C, 14A, 14B, and 14C, 15A, 15B, and 15C, and 16A, 16B, and 16C show curves respectively similar to the curves of FIGS. 11A, 11B, and 11C for different implementation modes of an embodiment of a recharge method.

For clarity, the same elements have been designated with the same reference numerals in the different drawings.

### DETAILED DESCRIPTION

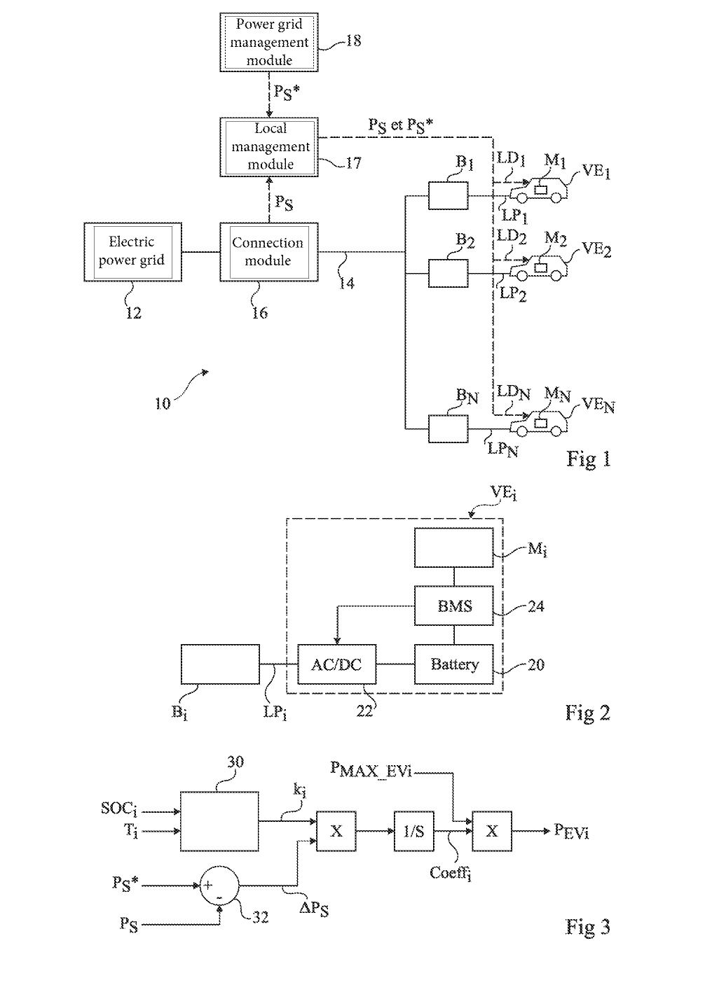

FIG. 1 shows an embodiment of a device 10 for recharging a fleet of N rechargeable electric or hybrid vehicles VEᵢ where i is an integer varying from 1 to N. As an example, N may vary from 10 to 100 vehicles being recharged.

Device 10 is connected to a main electric power grid 12. Device 10 comprises a local electric power grid 14 connected to main system 12 by a connection module 16. Local electric power grid 14 is capable of transmitting electric energy to N charging stations Bᵢ, with i varying from 1 to N. Connection module 16 may comprise a transformer, for example, capable of supplying an electric power which may vary from 200 kW to 2,000 kW. Connection module 16 further comprises a sensor capable of measuring the total electric power Pₛ supplied by main electric power grid 12 to local electric power grid 14.

A rechargeable electric or hybrid vehicle VEᵢ may be connected to one of charging stations Bᵢ to be recharged by an electric power transmission link LPᵢ. As an example, link LPᵢ corresponds to a power transmission cable. As a variation, the electric power transmission to electric vehicle VEᵢ may be performed remotely, for example, by induction. In the present embodiment, each electric VEᵢ comprises a control module Mᵢ capable of controlling an operation of recharge of electric vehicle VEᵢ. Each control module Mᵢ may comprise a dedicated processor and/or electronic circuit.

Device 10 comprises a local management module 17 which is capable of receiving data representative of the measured total electric power Pₛ supplied by connection module 16 and is capable of transmitting to control module Mᵢ of each vehicle VEᵢ the data representative of the measured total electric power Pₛ over a data transmission link LDᵢ, with i varying from 1 to N. It may be a wire link or a wireless link. Link LDᵢ may correspond to a RS-232 link or to a RS-485 link having data transmitted thereover according to a communication protocol, for example, the Modbus protocol. The transmission of the data representative of the measured total electric power Pₛ of local management module 17 to control modules Mᵢ may be performed at regular intervals.

A grid management module 18 is capable of transmitting to local management module 17 data representative of an electric power Pₛ*, called reference electric power, and corresponding to the required total electric power to be used for the recharge of vehicles VEᵢ. Local management module 17 is capable of transmitting the data representative of an electric power Pₛ* to control module Mᵢ of each vehicle VEᵢ over the corresponding communication link LDᵢ. A new value of reference power Pₛ* may be transmitted only when this power varies. According to an example, reference power Pₛ* may vary in stages and a new value of reference power Pₛ* is transmitted by local management module 17 to control modules Mᵢ only at the beginning of each new stage. According to another example, reference power Pₛ* varies continuously.

FIG. 2 shows a more detailed embodiment of certain components of electric vehicle VEᵢ. Each electric vehicle VEᵢ comprises a battery 20 intended to power equipment, not shown, of vehicle VEᵢ. Battery 20 is connected to an AC/DC converter 22 (AC/DC) which, during the recharge of the battery, is connected to station Bᵢ by power transmission link LPᵢ. Each vehicle VEᵢ comprises a battery control system 24 (BMS) which is capable, in particular, of controlling the power supplied by converter 22 to battery 20 during an operation of charge of battery 20. Control module Mᵢ is capable of transmitting a power setting to battery control system 24, based on which battery control system 24 controls converter 22. As a variation, control module Mᵢ may be provided at the level of each charging station Bᵢ. In this case, control module Mᵢ is capable of exchanging data with battery control system 24, for example, over a wire link or over a wireless link.

When a vehicle VEᵢ is connected to station Bᵢ, control module Mᵢ is supplied with the expected end time tₛₜₒₚᵢ. According to an example, the user of vehicle VEᵢ enters this information on an interface module of vehicle VEᵢ for example comprising a keyboard, a touch screen, a microphone, etc. The time at the beginning of the recharge iₛₜₐᵣₜᵢ of vehicle VEᵢ is automatically identified by control module Mᵢ.

Control module Mᵢ internally recovers once, at the beginning of the recharge, the maximum power P_{MAX}_{_}_{EVi} to which the battery of vehicle VEᵢ can be recharged.

During the recharge of vehicle VEᵢ, data representative of state of charge SOCᵢ of the vehicle are regularly transmitted to control module Mᵢ of vehicle VEᵢ. As a variation, data representative of state of charge SOCᵢ of the vehicle are transmitted to control module Mᵢ only at the beginning of the recharge, the control module determining the variation of state of charge SOCᵢ of vehicle VEᵢ based on the electric power supplied to recharge vehicle VEᵢ. Such data relative to state of charge SOCᵢ and to maximum power P_{MAX}_{_}_{EVi} are transmitted to control module Mᵢ with no intervention of the user.

According to an embodiment, control module Mᵢ may operate according to a basic operating mode where it performs no regulation of the electric power to be supplied to recharge vehicle VEᵢ. In this case, the power supplied to each vehicle is for example equal to maximum power P_{MAX}_{_}_{EVi}.

According to an embodiment, control module Mᵢ may operate according to a regulation operating mode where it determines in real time a setting P_{EVi}, for example, for battery control system 24, of the electric power to be supplied to recharge vehicle VEᵢ.

FIG. 3 shows in the form of a block diagram an embodiment of the method implemented by control module Mᵢ in regulation mode. Control module Mᵢ comprises a module 30 of determination of a correction coefficient kᵢ. Module 30 receives state of charge SOCᵢ of the vehicle and the time Tᵢ for which vehicle VEᵢ will be recharging. State of charge SOCᵢ corresponds to the state of charge of vehicle VEᵢ when a new value of coefficient kᵢ is determined. Time Tᵢ corresponds to the difference between time tₛₜₒₚᵢ and the time of beginning of the recharge tₛₜₐᵣₜᵢ. Control module Mᵢ comprises a subtractor 32 receiving electric powers P_{S}* and P_{S} and determining differences ΔPₛ between electric powers Pₛ* and Pₛ.

A weighting coefficient Coeffᵢ is determined from coefficient kᵢ and from difference ΔP_{S}. As an example, the regulation is of integral type, where difference ΔP_{S} is multiplied by coefficient kᵢ and is integrated. As a variation, it may be a correction of proportional-integral-derivative type.

Power setting P_{EVi} corresponds to the product of the value of maximum power P_{MAX}_{_}_{EVi} and of coefficient Coeffᵢ.

The control method may be implemented by the execution of a sequence of instructions by a processor. As a variation, it may be implemented by a dedicated electronic circuit.

According to an embodiment, for each control module Mᵢ, coefficient kᵢ is determined by fuzzy logic. For this purpose, the variables used by control module Mᵢ are the state of charge, SOC, the recharge time, T, and the correction coefficient, k.

The “state of charge” variable, SOC, is associated with a plurality of fuzzy sets, for example, five in the present embodiment, corresponding to a plurality of state of charge levels of the battery of vehicle VEᵢ.

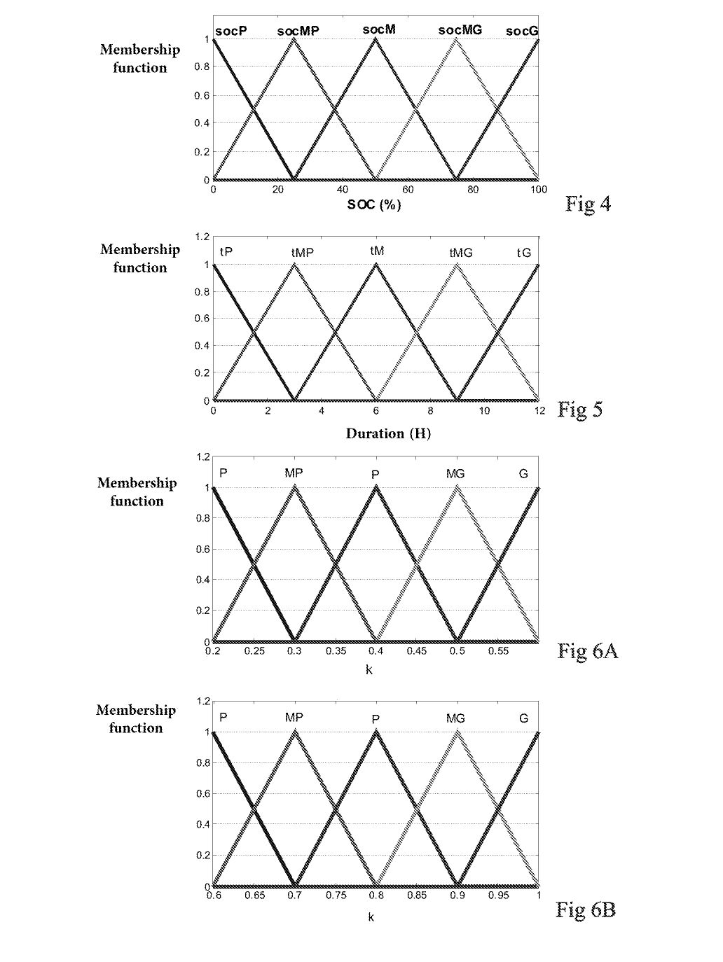

FIG. 4 shows examples of membership functions which characterize five fuzzy sets socP, socMP, socM, socMG, and socG of variable SOC respectively reflecting the fact that the state of charge is around 0%, 25%, 50%, 75%, and 100%.

The “recharge time” variable, T, is associated with a plurality of fuzzy sets, for example, five in the present embodiment, corresponding to a plurality of ranges of values of the recharge time.

FIG. 5 shows examples of membership functions which characterize five fuzzy sets tP, tMP, tM, tMG, and tG of variable SOC respectively reflecting the fact that the recharge time is around 0 hr, 3 hrs, 6 hrs, 9 hrs, and 12 hrs.

The “correction coefficient” variable, k, is associated with a plurality of fuzzy sets, for example, five in the present embodiment, corresponding to a plurality of ranges of values of the correction coefficient.

According to an embodiment, coefficient kᵢ is determined differently in case of a decrease or of an increase of the reference total electric power Pₛ*.

FIGS. 6A and 6B show, respectively in the case of a decrease of power Pₛ* and of an increase of power Pₛ*, examples of membership functions which characterize five fuzzy sets P, MP, M, MG, and G of variable k respectively reflecting the fact that the correction coefficient is “low”, “relatively low”, “average”, “relatively high”, and “high”.

The membership functions of the fuzzy sets of the “state of charge”, “recharge time”, and “correction coefficient” variables may be stored in memories of each control module Mᵢ.

In FIGS. 4, 5, 6A, and 6B, the membership functions correspond to broken lines. However the membership functions may have another shape, for example, a bell shape.

An example of a detection array, or inference table, in the case of a decrease in power Pₛ* is given by the following table (1):

TABLE (1)

| | | State of charge SOC | | | | |
|---|---|---|---|---|---|---|
| | | socP | socMP | socM | socMG | socG |
| Recharge | tP | P | P | MP | M | MG |
| time T | tMP | P | MP | MP | MG | G |
| | tM | P | MP | M | MG | G |
| | tMG | MP | M | M | MG | G |
| | tG | MP | M | MG | G | G |

In the case of a decrease in power Pₛ*, the membership function of variable k shown in FIG. 6A is used.

The reading of the fuzzy rule corresponding, for example, to the first box at the top left of inference table (1) is the following: if the state of charge is low (socP) and if the recharge time is short (tP), then coefficient k is low (P). This means that variable k belongs to fuzzy set P at a degree which depends on the degree of validity of the premises, in other words on the degree of membership of variable SOC to fuzzy set socP and on the degree of membership of variable T to fuzzy set tP.

Table (1) is not symmetrical. This illustrates the fact that coefficient kᵢ is low as a priority as soon as the state of charge is low. Indeed, the object is that the state of charge is at 100% at the time where the electric vehicle is disconnected from the associated charging station.

An example of the inference table in the case of an increase in power Pₛ* is given by the following table (2):

TABLE (2)

| | | State of charge SOC | | | | |
|---|---|---|---|---|---|---|
| | | socP | socMP | socM | socMG | socG |
| Recharge | tP | G | G | MG | M | MP |
| time T | tMP | G | MG | MG | MP | P |
| | tM | G | MG | M | MP | P |
| | tMG | MG | M | M | MP | P |
| | tG | MG | M | MP | P | P |

In the case of an increase in power Pₛ*, the membership function of variable k shown in FIG. 6B is used.

The reading of the fuzzy rule corresponding, for example, to the first box at the top left of inference table (2) is the following: if the state of charge is low (socP) and if the recharge time is short (tP), then coefficient k is high (G). This means that variable k belongs to fuzzy set G at a degree which depends on the degree of validity of the premises, in other words on the degree of membership of variable SOC to fuzzy set socP and on the degree of membership of variable T to fuzzy set tP.

Table (2) is not symmetrical. This illustrates the fact that coefficient kᵢ is high as a priority as soon as the state of charge is low. Indeed, the object is for the state of charge to be at 100% at the time where the electric vehicle is disconnected from the charging station.

In fuzzy logic, coordinating conjunction “and” which connects the premises translates as a fuzzy operator and linker “then” connecting the conclusion to the premises translates as a fuzzy implication.

As an example, the Zadeh fuzzy operators may be used. Intersection operator AND connecting two fuzzy sets then returns the minimum of the membership functions of the two fuzzy sets.

Generally, the fuzzy implication defines how to delimit, according to the specific values of variables SOC and T of the premises of the fuzzy rule, a portion of the surface under the curve of the membership function of the fuzzy set of the conclusion of the fuzzy rule, that is, the obtaining of a subset.

As an example, the fuzzy implication used may be the Mamdani implication or the Larsen implication.

For specific values SOCᵢ and Tᵢ of variables SOC and T, each fuzzy rule of the inference table results in the obtaining of a subset, possibly zero, for variable k. the subsets are aggregated by using, for example, operator MAX. The determination of the final value of coefficient kᵢ from the aggregated subsets is called defuzzification. As an example, the defuzzification step implements the mean-of-maxima method or the center-of-gravity method.

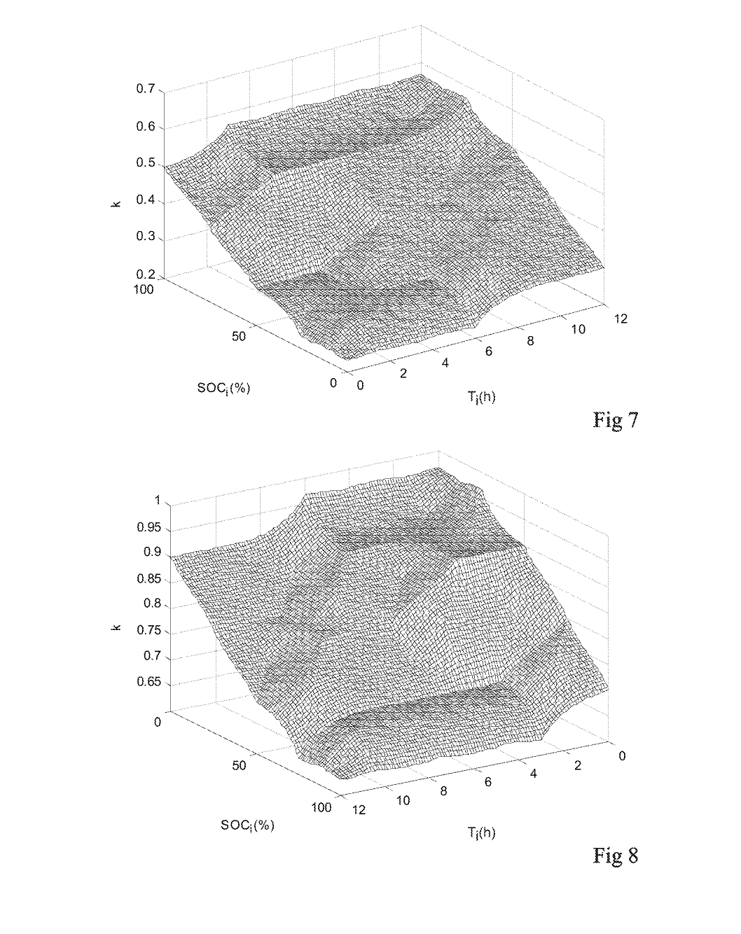

FIGS. 7 and 8 show an example of a three-dimensional representation of the variation of coefficient kᵢ according to state of charge SOCᵢ and to recharge time Tᵢ on implementation, respectively, of inference table (1) and of inference table (2) by using Zadeh's fuzzy “AND” operator, Mamdani's fuzzy implication and the step of defuzzification by the center-of-gravity method.

As an illustration, two vehicles VE₁ and VE₂ are considered. State of charge SOC₁ of vehicle VE₁ is higher than state of charge SOC₂ of vehicle VE₂ and charge time T₁ of vehicle VE₁ is longer than charge time T₂ of vehicle VE₂.

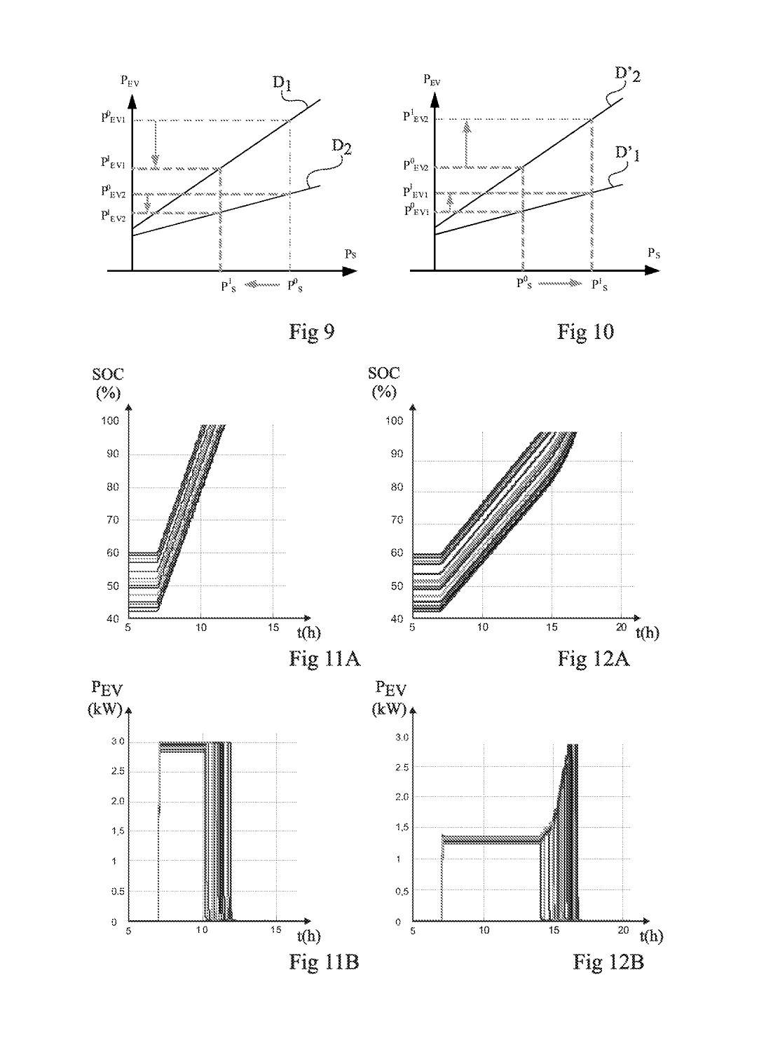

FIG. 9 shows curves D₁ and D₂ of the variation of the electric power P_{Ev1} supplied to vehicle VE₁ and of the electric power P_{EV2} supplied to vehicle V_{E2} according to the total available electric power Pₛ respectively when a decrease in the total available power from P⁰ₛ to P¹ₛ is indicated by system management module 18 at stations Bᵢ, with i varying from 1 to N. Curves D₁ and D₂ correspond to straight lines, coefficient k₁ corresponding to the slope of line D₁ and coefficient k₂ corresponding to the slope of line D₂.

FIG. 9 shows that, on decrease of the total available electric power, the decrease in the electric power supplied to a vehicle is all the more significant as its state of charge is high and as the recharge time is long.

FIG. 10 shows variation curves D′₁ and D′₂ similar to respective lines D₁ and D₂ when an increase in the total available power from P⁰ₛ to P¹ₛ is indicated by system management module 18 to control modules Mᵢ, with i varying from 1 to N.

FIG. 10 shows that, on increase of the total available electric power, the increase in the electric power supplied to a vehicle is all the more significant as its state of charge is low and as the recharge time is short.

An advantage of the present embodiment is that it is essentially formed locally by each control module of the electric vehicle and only requires the remote transmission of a small number of data.

Another advantage of the present embodiment is that it requires no information which may be difficult to obtain, for example, the type of vehicle to be recharged.

Another advantage of the present embodiment is that it does not require knowing in advance the number of vehicles to be recharged or the times of arrival of the vehicles to be recharged.

Another advantage of the present embodiment is that it may be implemented in real time.

Another advantage of the present embodiment is that the electric power setting P_{VEi} supplied by control module Mᵢ of each vehicle VEᵢ may be determined continuously so that the total electric power Pₛ supplied to all the electric vehicles may continuously follow reference power Pₛ*.

Another advantage of the present embodiment is that reference power Pₛ* does not have to be determined in advance. Thereby, reference power Pₛ* may follow the electric power supplied by an electric power plant, particularly a photovoltaic power plant, a wind power station, a hydraulic power plant, or a tidal power plant.

Simulations have been performed by the inventors. For all these simulations, twenty electric vehicles each having a battery having a 24-KWh capacity with a maximum charge power of 3 kW have been considered.

For the first simulation, initial state of charge SOCᵢₙᵢ of the electric vehicles was between 40% and 60% and has been obtained by a random selection according to a uniform distribution. Time tₛₜₐᵣₜ of beginning of the recharge was 7 am for all vehicles and end time tₛₜₒₚ of the recharge was between 4:30 pm and 7 pm and has been obtained by random selection. These values are gathered in the following table (3):

TABLE 3

| | Tₛₜₐᵣₜ | Tₛₜₒₚ | SOCᵢₙᵢ |
|---|---|---|---|
| VE | (hrs from midnight) | (hrs from midnight) | (%) |
| 1 | 7 | 18.6 | 45 |
| 2 | 7 | 18.0 | 50 |
| 3 | 7 | 17.9 | 54 |
| 4 | 7 | 18.8 | 58 |
| 5 | 7 | 17.2 | 60 |
| 6 | 7 | 18.4 | 51 |
| 7 | 7 | 18.4 | 42 |
| 8 | 7 | 17.5 | 43 |
| 9 | 7 | 17.9 | 45 |
| 10 | 7 | 16.7 | 57 |
| 11 | 7 | 16.6 | 45 |
| 12 | 7 | 17.8 | 57 |
| 13 | 7 | 18.4 | 45 |
| 14 | 7 | 18.8 | 59 |
| 15 | 7 | 16.8 | 47 |
| 16 | 7 | 17.9 | 44 |
| 17 | 7 | 17.7 | 45 |
| 18 | 7 | 16.5 | 52 |
| 19 | 7 | 17.3 | 49 |
| 20 | 7 | 16.9 | 47 |

For the first simulation, there is no determination of a charge power setting, each vehicle being recharged to the maximum charge power.

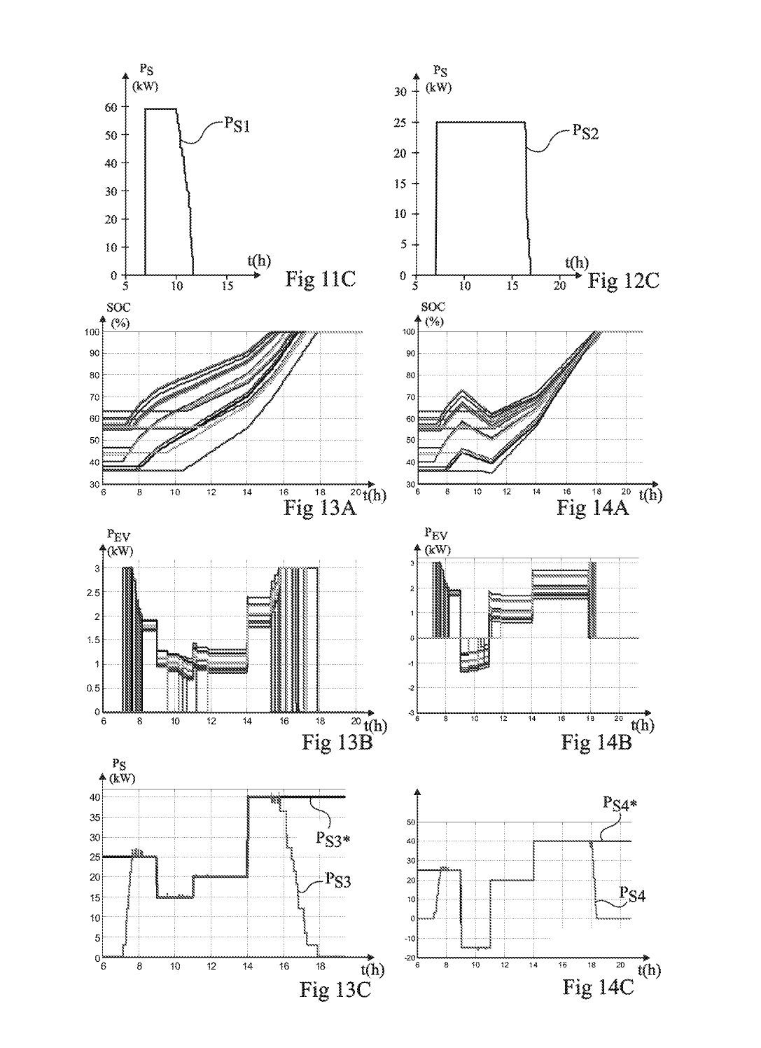

FIGS. 11A, 11B, and 11C show curves of the variation, respectively, of states of charge SOC of the electric vehicles, of electric power P_{EV} supplied to each electric vehicle, and of total electric power Pₛ₁ supplied to the electric vehicles for the first simulation.

As appears in the drawings, each vehicle has been recharged with the maximum 3-kW charge power during the entire recharge period. Total electric power P_{S1} was thus as high as 60 kW as long as all vehicles were recharging and then decreased down to 0 kW as the state of charge of each vehicle reached 100%.

A second simulation has been carried out with the same conditions as the first simulation, with the difference that the total reference power starting from 7 am was 25 kW.

FIGS. 12A, 12B, and 12C are curves similar to the respective curves of FIGS. 11A, 11B, and 11C for the second simulation. The total supplied power P_{S2} has been kept at 25 kW and the state of charge of all the vehicles was 100% at the end time.

A third simulation has been performed with the same conditions as the second simulation, with the difference that the time of beginning of the recharge tₛₜₐᵣₜ was between 7 am and 12 am and has been obtained by random selection and that total reference power P*_{S3} was successively 25 kW from 12 am to 9 am, 15 kW from 9 am to 11 am, 20 kW from 11 am to 2 pm, and 40 kW from 2 pm to midnight. A new value of total reference power P*_{S3} was thus transmitted to each charging station at 12 am, 9 am, 11 am, and 2 pm.

FIGS. 13A, 13B, and 13C are curves similar to the respective curves of FIGS. 11A, 11B, and 11C for the third simulation. FIG. 13C shows, in addition to total power P_{S3}, the curve of variation of the total reference power P*_{S3} by a thick line. The total supplied power P_{S3} follows the variation curve of the total reference power P*_{S3} and the state of charge of all the vehicles was 100% at the end time.

A fourth simulation has been carried out in the case where the electric vehicles are further capable of supplying electric energy to the main power grid. The fourth simulation has been performed with the same conditions as the third simulation, with the difference that total reference power P*_{S4} was successively 25 kW from midnight to 9 am, −15 kW from 9 am to 11 am, 20 kW from 11 am to 2 pm, and 40 kW from 2 pm to midnight. A new value of total reference power P*_{S4} was thus transmitted to each charging station at midnight, 9 am, 11 am, and 2 pm.

FIGS. 14A, 14B, and 14C are curves similar to the respective curves of FIGS. 11A, 11B, and 11C for the fourth simulation. FIG. 14C shows, in addition to total power P_{S4}, the curve of variation of the total reference power P*_{S4} by a thick line. The total supplied power P_{S4} follows the variation curve of the total reference power P*_{S4} and the state of charge of all the vehicles was 100% at the end time.

A fifth simulation has been carried out in the absence of a control. For the fifth simulation, initial state of charge SOCᵢₙᵢ of the electric vehicles was between 20% and 80% and has been obtained by a random selection according to a uniform distribution. The time tₛₜₐᵣₜ of beginning of the recharge was in the range from 7 am to midnight and has been obtained by random selection and end time tₛₜₒₚ of the recharge was between 7 pm and 9 pm and has been obtained by a random selection. These values are gathered in the following table (4):

TABLE 4

| | Tₛₜₐᵣₜ | Tₛₜₒₚ | SOCᵢₙᵢ |
|---|---|---|---|
| VE | (hrs from midnight) | (hrs from midnight) | (%) |
| 1 | 8.02 | 20.5 | 54.67 |
| 2 | 7.97 | 19.5 | 36.07 |
| 3 | 8.85 | 20 | 60.47 |
| 4 | 10.22 | 20.38 | 63.02 |
| 5 | 11.17 | 20.77 | 55.36 |
| 6 | 8.12 | 20.92 | 57.73 |
| 7 | 8.95 | 20.08 | 57.29 |
| 8 | 8.65 | 19.27 | 46.77 |
| 9 | 7.52 | 19.28 | 54.66 |
| 10 | 8.47 | 19.5 | 40.14 |
| 11 | 8.18 | 20.67 | 56.18 |
| 12 | 10.4 | 19.5 | 35.95 |
| 13 | 8.43 | 20.62 | 43.31 |
| 14 | 8.83 | 19.48 | 36.39 |
| 15 | 8.18 | 20.58 | 37.91 |
| 16 | 9.08 | 19.68 | 59.7 |
| 17 | 8.37 | 19.38 | 55.84 |
| 18 | 9.58 | 19.5 | 44.51 |
| 19 | 10.68 | 20.22 | 63.51 |
| 20 | 11.8 | 19.93 | 56.03 |

For the fifth simulation, there is no determination of a charge power setting, each vehicle being recharged to the maximum charge power.

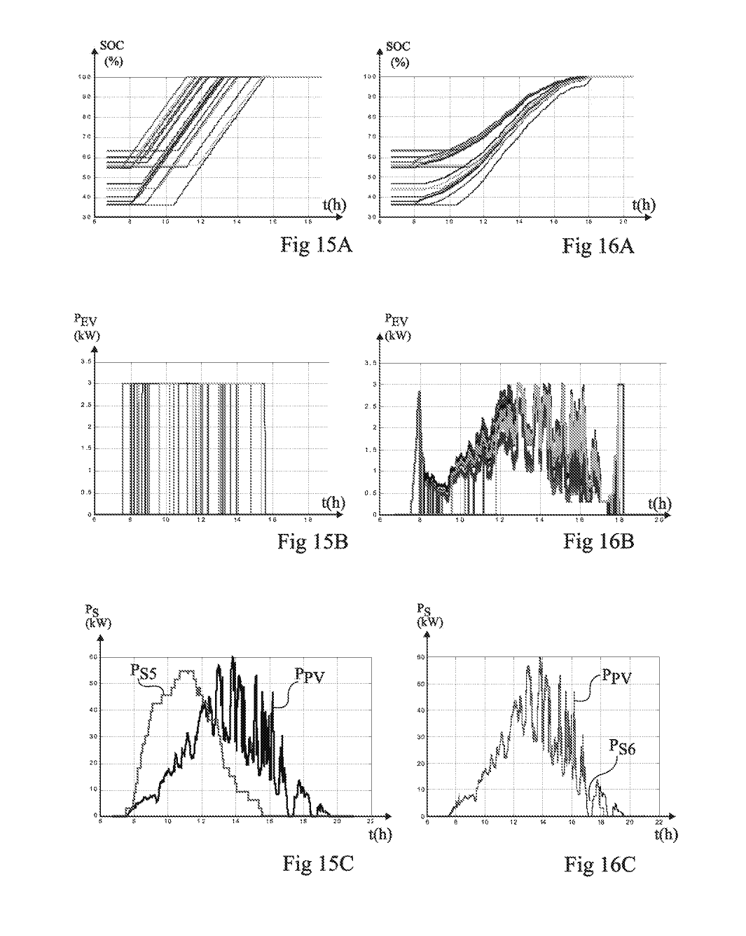

FIGS. 15A, 15B, and 15C are curves similar to the respective curves of FIGS. 11A, 11B, and 11C for the fifth simulation. In FIG. 15C, curve P_{S5} shows the curve of variation of the total electric power and curve P_{PV} shows the electric power supplied by a photovoltaic power plant.

For the fifth simulation, the solar coverage is 55.62%, that is, 55.62% of the total electric power Pₛ supplied to the vehicles to be recharged has been provided by the photovoltaic power plant.

A sixth simulation has been performed with the same conditions as the fifth simulation, with the difference that the setting for total available power P*_{S} corresponds to the electric power P_{PV} shown in FIG. 15C.

FIGS. 16A, 16B, and 16C are curves similar to the respective curves of FIGS. 11A, 11B, and 11C for the sixth simulation.

For the sixth simulation, the solar coverage is 97.88%, that is, 97.88% of the total electric power P_{S6} supplied to the vehicles to be recharged has been provided by the photovoltaic power plant.

Specific embodiments have been described. Various alterations and modifications will readily occur to those skilled in the art.

1. A method of recharging electric or hybrid vehicles by means of charging stations connected to an electric power grid, the method comprising the steps of:
supplying, for each vehicle to be recharged, a control module built into said vehicle or into the charging station of said vehicle with data representative of a total electric power required for recharging the vehicles;
measuring the total electric power supplied by the electric power grid for recharging the vehicles and supplying data representative of the measured total electric power to said control module for each vehicle to be recharged; and
determining, by means of said control module for each vehicle to be recharged, a first coefficient by fuzzy logic based on the state of charge of the vehicle and on the recharge time of the vehicle and determining a setting of the electric charge power of said vehicle based on the first coefficient and based on the difference between the required total electric power and the measured total electric power.

2. The method of claim 1, wherein the setting of the electric charge power of said vehicle is further determined based on the state of charge of the vehicle, on the recharge time of the vehicle.

3. The method of claim 1, wherein the data representative of the required total electric power are provided by the power grid manager and/or by at least one electric power plant selected from the group comprising a photovoltaic power plant, a wind power station, a hydraulic power plant, or a tidal power station.

4. The control method of claim 1, further comprising the step of multiplying the maximum electric charge power of said vehicle by a second coefficient obtained from the first coefficient and from the measured total electric power.

5. The control method of claim 4. comprising the steps of:
determining the difference between the required total electric power and the measured total electric power; and
determining the second coefficient based on the product between the first coefficient and said difference.

6. The control method of claim 5, wherein the second coefficient is equal to the integral of the product between the first coefficient and said difference.

7. The control method of claim 1, wherein the determination of the first coefficient by fuzzy logic comprises determining first values of first membership functions of first fuzzy sets associated with the state of charge of the vehicle and second values of second membership functions of second fuzzy sets associated with the vehicle recharge time.

8. The control method of claim 7, wherein the determination of the first coefficient by fuzzy logic comprises using a first inference table and a third membership function for the first coefficient on decrease of the required total electric power and a second inference table, difference from the first inference table, and a fourth membership function for the first coefficient different from the third membership function on increase of the required total electric power.

9. A device for recharging electric or hybrid vehicles, comprising charging stations connected to an electric power grid, each charging station being connected to one of the vehicles to be recharged, the device further comprising, for each vehicle to be recharged, a control module built into said vehicle or into the charging station of said vehicle, the device comprising means for transmitting, to the control module for each vehicle to be recharged, data representative of a required total electric power for recharging the vehicles, the device further comprising a sensor capable of measuring the total electric power supplied by the electric power grid for recharging said vehicles and means for transmitting data representative of the measured total electric power to the control module for each vehicle to be recharged, said control module for each vehicle to be recharged being capable of determining a first coefficient by fuzzy logic based on the state of charge of the vehicle and on the recharge time of the vehicle and of determining a setting of the electric power for recharging said vehicle based on the first coefficient and on the state of charge of the vehicle, on the recharge time of the vehicle, and on the difference between the required total electric power and the measured total electric power.
